(19) United States
(12) Patent Application Publication
(10) Pub. No.: US 2004/0182984 A1
(43) Pub. Date: Sep. 23, 2004

(54) Guitar stand

(76) Inventor: Donald Lee Sandkuhl, Broken Arrow, OK (US)

Correspondence Address: Donald Lee Sandkuhl, 2109 W. Waco St., Broken Arrow, OK, 74011, US

(21) Appl. No.: 10/777,339

(22) Filed: Feb. 12, 2004

Related U.S. Application Data
(60) Provisional application No. 60/448,451, filed on Feb. 21, 2003.

(51) Int. Cl. G10G 5/00

(52) U.S. Cl. 248/443; 248/463; 84/327

(57) ABSTRACT

The guitar tand has a short hinge leaf, used to attach the guitar stand to a guitar with screws, a hinge pin and a long hinge leaf with attached cross plate. The cross plate has two feet on the bottom that are covered with vinyl boots. The guitar stand has an open position that is used when the guitar stand is holding the guitar on the floor, and a closed position that is used while a musician is playing the guitar or when the guitar and guitar stand are stored in a guitar case. VELCRO® fasteners, on the rear of the cross plate and the guitar, are used to hold the guitar stand in the closed position, while playing the guitar. The guitar stand is narrow enough that when the guitar stand is in the closed position, the guitar and attached guitar stand can easily fit inside a guitar case.

### CROSS-REFERENCE TO RELATED APPLICATIONS

This application claims the benefits of my Provisional Patent Application 60448451, filed Feb. 21, 2003.

### STATEMENT REGUARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

(a) Field of the Invention

The present invention relates, in general, to a guitar stand that becomes an integral part of the guitar, when attached to the neck plate of the guitar with screws. The guitar stand is in the open position when setting on the floor holding the guitar and the guitar stand is in the closed position, next to the guitar, while played by a musician. The guitar stand is narrow enough, when closed next to a guitar, to store with the guitar in a hardshell guitar case.

(b) Description of the Prior Art

Conventional guitar stands serve simply to support guitars. Conventional guitar stands are inconvenient to carry or store, because the guitar stand must be carried or stored separately from the guitar. There are no provisions for storing a guitar and guitar stand together in a hardshell guitar case, in older conventional guitar stand designs.

Additional inconvenience occurs with conventional guitar stands, because the musician has to go find wh re th guitar stand is located before the guitar is placed on the guitar stand. Additional inconvenience occurs with conventional guitar stands, because a musician must carry a conventional guitar stand separately from their guitar and guitar case when traveling.

### SUMMARY OF THE INVENTION

A new and novel guitar stand inv ntion is disclosed and described. The guitar stand is attached permanently to a guitar with screws on the guitar neck plate and thereby becomes an integral part of the guitar. The guitar stand provides for open and closed positions of the guitar stand. The open position is used when the guitar stand is holding and supporting the guitar on the floor. The closed position, with the guitar stand next to the guitar, is used whil a person is playing the guitar, or when the guitar is stored in a guitar case.

The guitar stand consists of a stop hinge with a short hinge leaf, a long hinge leaf, a cross plate with extension feet, vinyl boots that cover the extension feet and a VELCRO® fastener on the cross plate.

The short hinge leaf has two counter sunk holes through which two screws are placed to connect the guitar stand to the neck plate of the guitar. The long hinge leaf is riveted to a cross plate that has extension feet that stabilize the guitar stand and guitar while they are setting on the floor. Two vinyl boots are placed on the extension feet, of the cross plate, to prevent the guitar stand from sliding, when the guitar and guitar stand are setting on the floor. A VELCRO® fastener is attached to the rear of the guitar stand cross plate. The guitar also has a mating VELCRO® fastener, on the back of the guitar, used to secure the bottom of the guitar stand to the guitar when the guitar stand is in the closed position.

The guitar stand is placed in the open position when the long hinge leaf and cross plate of the guitar stand are pulled away from the guitar by the musician. The guitar stand stop hinge limits how far the long hinge leaf and cross plate of the guitar stand are permitted to move away from the guitar, when the guitar stand and guitar are setting on the floor.

The musician places the guitar stand in the closed position, when the long hinge leaf and cross plate of the guitar stand are pulled back, next to the guitar. The VELCRO® fastener on the back of the cross plate secures the bottom of the guitar stand to the mating fastener on the back of the guitar, while the guitar is being played or stored in the guitar case.

When the guitar stand is used in the open position, the long leaf and cross bar of the guitar stand support the guitar when it is setting on the floor. When the guitar stand is used in the closed position, the guitar stand is narrow enough for the guitar to be easily played by a musician. The guitar stand is also narrow enough that when th guitar stand is in the closed position, the guitar and guitar stand can both fit inside a hardshell guitar case.

### BRIEF DESCRIPTION OF THE SEVERAL VIEWS OF THE DRAWINGS

FIG. 1 is a perspective view of the guitar stand invention showing the preferred “closed stop hinge” embodiment of the invention. The view of the guitar stand shows the guitar stand in the open position that is used when the guitar and guitar stand are setting on the floor.

FIG. 2 is a perspective view of the guitar stand invention showing a modified “open stop hinge” embodiment of the invention. The view of the guitar stand shows the guitar stand in the open position that is used when the guitar and guitar stand are setting on the floor.

### DETAILED DESCRIPTION OF THE INVENTION

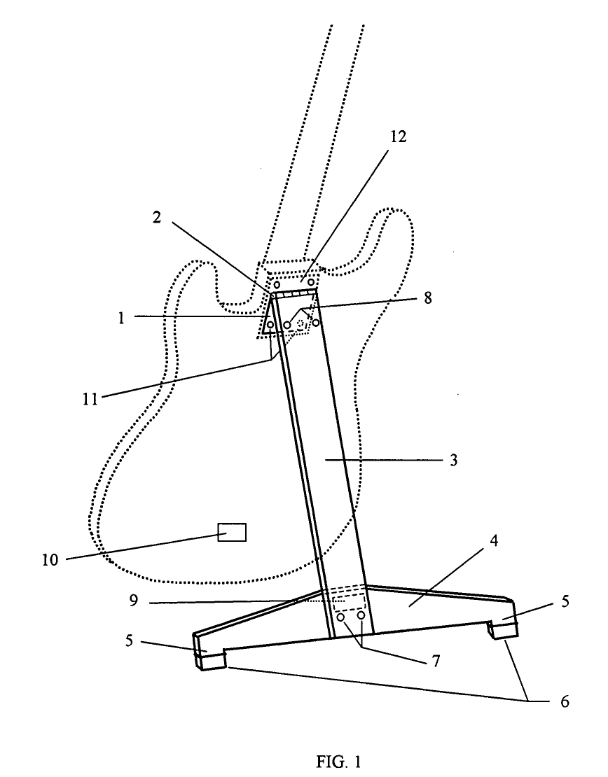

The preferred embodiment of the guitar stand invention consists of the embodiments of the inside stop hinge guitar stand described below and as illustrated in FIG. 1. The guitar stand consists of the following components: a short hinge leaf 1 with two counter sunk holes 11, through which two screws are placed to secure the guitar stand to the two bottom holes on the guitar neck plate 12, an inside stop hinge barrel and pin 2, a long hinge leaf 3, a cross plate 4, with two extension feet 5 and two vinyl boots 6 that prevent the guitar stand and guitar from sliding when they are setting on the floor, rivets 7 that connect the long hinge leaf 3 and cross plate 4 together, two screw access holes 8 in the long hinge leaf 3 so a screw driver can be used to tighten the screws holding the guitar stand to the guitar during installation of the guitar stand, and a VELCRO® fastener 9 on the rear of the cross plate 5. A mating VELCRO® fastener 10, is attached to the back of the guitar to secure the guitar stand when it is in the closed position.

The guitar stand is in the open position when the long hinge leaf 3 and cross plate 4 of the guitar stand are pulled away from the guitar. The inside stop hinge barrel 2 limits how far out the bottom of the long hinge leaf 3 and cross plate 4 are permitted to travel in the open position. The guitar stand is placed in the closed position when the long hinge leaf 3 and cross plate 4 of the guitar stand are placed next to the guitar. The bottom of the guitar stand is secured to the guitar by the VELCRO® fasteners on the cross plate and the guitar.

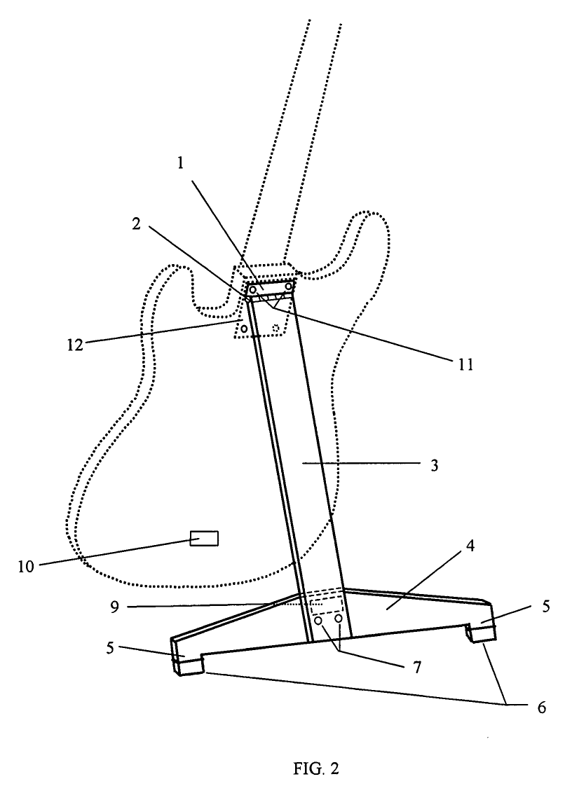

A modified embodiment of the guitar stand invention consists of the embodiments of the outside stop hinge guitar stand described below and as illustrated in FIG. 2. The guitar stand consists of the following components: a short hinge leaf 1 with two counter sunk holes 11, through which two screws are placed to secure the guitar stand to the top two holes on the guitar neck plate 12, an outside stop hinge barrel and pin 2, a long hinge leaf 3, a cross plate 4, with two extension feet 5 and two vinyl boots 6 that prevent the guitar stand and guitar from sliding when they are setting on the floor, rivets 7 that connect the long hinge leaf 3 and cross plate 4 together, and a VELCRO® fastener 9 on the rear of the cross plate 5. A mating VELCRO® fastener 10, is attached to the back of the guitar to secure the guitar stand when it is in the closed position.

The guitar stand is in the open position when the long hinge leaf 3 and cross plate 4 of the guitar stand are pulled away from the guitar. The inside stop hinge barrel 2 limits how far out the bottom of the long hinge leaf 3 and cross plate 4 are permitted to travel in the open position. The guitar stand is placed in the closed position when the long hinge leaf 3 and cross plate 4 of the guitar stand are placed next to the guitar. The bottom of the guitar stand is secured to the guitar by the VELCRO® fasteners on the cross plate and the guitar.

Incidentally, it should be understood that the guitar stand of the present invention is not only available for use as a guitar stand for a guitar, but may also be used as a guitar stand for a bass guitar.

As described above, the present guitar stand invention provides for a guitar stand that is lightweight and is easily closed next to the guitar when played or when the guitar is stored with the guitar stand in a guitar case, a guitar stand that is physically capable of supporting the guitar reliably on the floor with a certain degree of impact, and a guitar stand that allows advertisements to appear on its long hinge leaf for advertising purposes.

Although the preferred embodiment and a modified embodiment of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A guitar stand, comprising:
a first short hinge leaf, used to fasten the guitar stand to the guitar with screws;
a second long hinge leaf, with attached cross plate that stabilizes the guitar stand;
a hinge pin, that holds the short hinge leaf and long hinge leaf of the hinge together;
a cross plate, with two extension feet, that is riveted to the second long hinge leaf;
a pair of vinyl boots, that cover the extension feet on the cross plate;
a VELCRO® fastener, attached to the cross plate of the guitar stand;
a mating VELCRO® fastener, attached to the rear of the guitar.

2. A guitar stand that can be attached to a guitar with screws.

3. A guitar stand with a stop hinge that limits how far the guitar stand can open.

4. The guitar stand according to claim 1, further comprises a second long leaf and a cross plate that has two extension feet and vinyl boots that prevent the guitar stand from sliding on the floor, while the guitar is being supported by the guitar stand as it sets on the floor; and further understanding that the cross plate is connected to the second hinge leaf by rivets; also understanding that the second long hinge leaf and the cross plate and can be fabricated as a single unit, made from one piece of material, to facilitate manufacture of the guitar stand.

5. The guitar stand according to claim 3, further comprises a first short hinge leaf, a second long hinge leaf, and a hinge barrel that function as a stop hinge that limits how far the second long hinge leaf of the guitar stand can open away from the guitar.
